(19) United States
(12) Patent Application Publication
(10) Pub. No.: US 2013/0283286 A1
(43) Pub. Date: Oct. 24, 2013

(54) APPARATUS AND METHOD FOR RESOURCE ALLOCATION IN CLUSTERED COMPUTING ENVIRONMENT

(71) Applicant: Electronics and Telecommunications Research Institute, (US)

(72) Inventors: Hun-Soon LEE, Daejeon (KR); Byoung-Seob Kim, Daejeon (KR); Seung-Jo Bae, Daejeon (KR)

(73) Assignee: Electronics and Telecommunications Research Institute, Daejeon-city (KR)

(21) Appl. No.: 13/764,882

(22) Filed: Feb. 12, 2013

(30) Foreign Application Priority Data
Apr. 23, 2012 (KR) 10-2012-0042313

(51) Int. Cl. G06F 9/50

(52) U.S. Cl. CPC G06F 9/50
USPC 718/104

(57) ABSTRACT

An apparatus for resource allocation in a clustered computing environment includes: a node search unit configured to search for a node corresponding to necessary resources required for running a job requested by a user, within an available resource group of the clustered computing environment; a node existence determination unit configured to determine whether or not there exists a node having the necessary resources available; and a resource changing unit configured to change at least one of the necessary resources to alternative resources based on a preset priority and then allocate the alternative resource, when it is determined that there is no node having the necessary resources available.

### CROSS-REFERENCE(S) TO RELATED APPLICATIONS

This application claims priority to Korean Patent Application No. 10-2012-0042313 filed on Apr. 23, 2012 which is incorporated herein by reference in its entirety.

### BACKGROUND OF THE INVENTION

1. Field of the Invention

Exemplary embodiments of the present invention relate to an apparatus and method for resource allocation in a clustered computing environment; and, particularly, to an apparatus and method for resource allocation in a clustered computing environment, which allocates resources to run a job requested by a user in a clustered environment including heterogeneous computing resources.

2. Description of Related Art

Recently, research has been actively conducted to achieve higher performance by utilizing heterogeneous computing resources having different performances and functions, such as central processing units (CPU), general purpose graphic processing units (GPGPU), and many integrated cores (MIC), in a high-performance computing field.

A system which manages computing resources to efficiently utilize the resources and allocates the resources to run jobs requested by a user in an optimal order in such a clustered environment including heterogeneous computing resources refers to a Resource and Job Management System (hereafter, “RJMS”).

In general, the RJMS runs a job according to the following sequence. First, the RJMS searches for a node satisfying a resource request of a user in an available resource pool. Then, the RJMS determines whether or not there exists a node having an available resource to satisfy the corresponding request. When it is determined that there is no node having an available resource to satisfy the request, the RJMS waits for a predetermined time, and then searches for a node satisfying the resource request of the user. When it is determined that there exists a node having an available resource, the RJMS allocates the resource of the corresponding node to run the corresponding job. When the resource is allocated, the RJMS run the job using the allocated resource.

For example, Korean Patent Laid-open Publication No. 2004-0077512 discloses a method and system for delayed allocation of resources. As disclosed in the document, when a resource requested by a user is not available, the system must wait until the corresponding resource becomes available, even though other resources are in an idle state. Accordingly, the user's response time inevitably increases, and the utilization rate of resources in the system decreases.

### SUMMARY OF THE INVENTION

An embodiment of the present invention is directed to an apparatus and method for resource allocation in a clustered computing environment including heterogeneous computing resources, which does not wait until a node having available necessary resources required for running a job requested by a user emerges, but allocates alternative resources to run the job, thereby shortening a user's response time and improving the overall performance of the system.

Another embodiment of the present invention is directed to an apparatus and method for resource allocation in a clustered computing environment, which constructs and utilizes uniform standards for changing necessary resources required for running a job requested by a user to alternative resources, thereby improving the utilization of the entire resources and increasing the efficiency of the system operation.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, an apparatus for resource allocation in a clustered computing environment includes: a node search unit configured to search for a node corresponding to necessary resources required for running a job requested by a user, within an available resource group of the clustered computing environment; a node existence determination unit configured to determine whether or not there exists a node having the necessary resources available; and a resource changing unit configured to change at least one of the necessary resources to alternative resources based on a preset priority and then allocate the alternative resource, when it is determined that there is no node having the necessary resources available.

The clustered computing environment may be constructed based on a plurality of many integrated cores (MIC), general purpose graphic processing units (GPGPU), and central processing units (CPU).

The resource changing unit may change the necessary resources which are rare to the alternative resources preferentially among the necessary resources in the clustered computing environment. That is, the resource changing unit would rather change the MICs or GPGPUs which are relatively rare to the alternative resources than the CPUs which are relatively common.

The resource changing unit may include: a priority setting section configured to set the priority of the necessary resources and the alternative resources in order of MIC, GPGPU, and CPU; a changing section configured to change at least one of the necessary resources to the alternative resources based on the preset priority; and a resource transmitting section configured to transmit the changed alternative resources to the node search unit.

The apparatus may further include a resource allocation unit configured to allocate necessary resources of a node, when the node existence determination unit determines that the corresponding node has the necessary resources available.

The apparatus may further include a job execution unit configured to receive the necessary resources of the corresponding node or the alternative resources and execute the job requested by the user.

The job execution unit may include: a resource receiving section configured to receive the necessary resources of the corresponding node determined by the node existence determination unit or the alternative resources; a code converting section configured to convert codes for the job so that the job can be executed on the alternative resources, when the alternative resources are received; a running section configured to run the requested job using the received necessary resources of the corresponding node or the converted alternative resources; and a monitoring section configured to monitor whether the necessary resources become available or not, when the alternative resources are used to run the requested job.

In accordance with another embodiment of the present invention, a method for resource allocation in a clustered computing environment includes: searching for, by a node search unit, a node corresponding to necessary resources required for running a job requested by a user, within an available resource group of the clustered computing environment; determining, by a node existence determination unit, whether or not there exists a node having the necessary resources available; and changing, by a resource changing unit, the necessary resources to alternative resources based on a preset priority and allocating the alternative resources, when it is determined that there is no node having the necessary resources available.

In changing the necessary resources to the alternative resources based on the preset priority, and allocating the alternative resources, when it is determined that there is no node having the necessary resources available, the resource changing unit may change the necessary resources which are rare to the alternative resources preferentially among the necessary resources in the clustered computing environment.

In changing the necessary resources to the alternative resources based on the preset priority, and allocating the alternative resources, when it is determined that there is no node having the necessary resources available, the resource changing unit may change at least one of the necessary resources to the alternative resources based on the priority set in order of MIC, GPGPU, and CPU, and allocate the changed alternative resources.

The method may further include allocating, by a resource allocating unit, necessary resources of a node, when the node existence determination unit determines that the corresponding node has the necessary resources available, after changing the necessary resources to the alternative resources based on the preset priority and allocating the alternative resources, when it is determined that there is no node having the necessary resources available.

The method may further include receiving, by a job execution unit, the necessary resources of the corresponding node or the alternative resources and executing the job requested by the user, after allocating the necessary resources of the node, when the corresponding node existence determination unit determines that the node has the necessary resources available.

In receiving the necessary resources of the corresponding node or the alternative resources and running the job requested by the user, when the alternative resources are allocated, a code converting section may convert codes for the job so that the job can be executed on the alternative resources, and a monitoring section may monitor whether the necessary resources become available or not, when the alternative resources are used to execute the requested job.

In receiving the resources of the alternative resources and running the job requested by the user, when it is determined that the necessary resources become available, the job execution unit may receive the corresponding resources to execute the job again, or move the job executed in the alternative resources to the necessary resources required for running the job.

### BRIEF DESCRIPTION OF THE DRAWINGS

FIG. 1 is a diagram illustrating the configuration of an apparatus for resource allocation in a clustered computing environment in accordance with an embodiment of the present invention.

FIG. 2 is a diagram illustrating the detailed configuration of a resource changing unit employed in the apparatus for resource allocation in a clustered computing environment in accordance with the embodiment of the present invention.

FIG. 3 is a table which is referred to by the resource changing unit employed in the apparatus for resource allocation in a clustered computing environment in accordance with the embodiment of the present invention, when the resource changing unit changes necessary resources to alternative resources.

FIG. 4 is a diagram illustrating the configuration of a job execution unit employed in the apparatus for resource allocation in a clustered computing environment in accordance with the embodiment of the present invention.

FIG. 5 is a diagram illustrating an example in which alternative resources are used to run a job using the job execution unit employed in the apparatus for resource allocation in a clustered computing environment in accordance with the embodiment of the present invention.

FIG. 6 is a flow chart showing a method for resource allocation in a clustered computing environment in accordance with the embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

Hereafter, an apparatus and method for resource allocation in a clustered computing environment in accordance with an embodiment of the present invention will be described in detail with reference to the accompanying drawings.

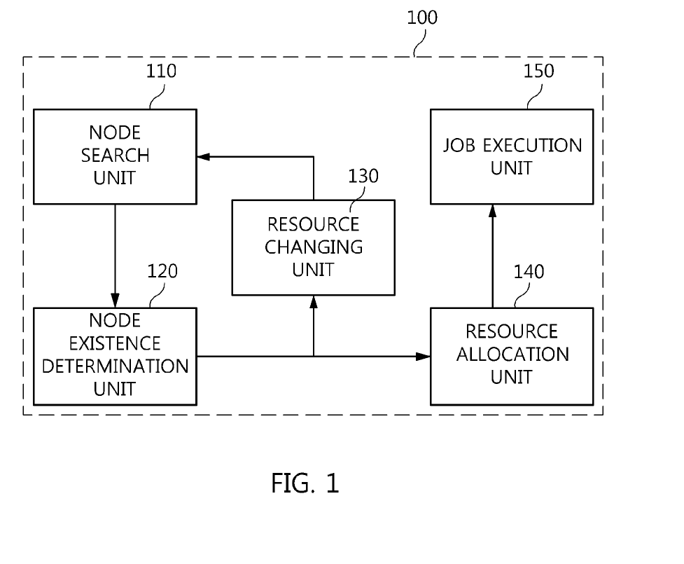

Referring to FIG. 1, the resource allocation apparatus 100 in accordance with the embodiment of the present invention includes a node search unit 110, a node existence determination unit 120, a resource changing unit 130, a resource allocation unit 140, and a job execution unit 150.

Here, the clustered computing refers to a group of computers connected together to calculate a large amount of calculation or store a large amount of data. At this time, each of the computers refers to a node. Each node runs its own instance of an operating system. Computer clusters may be a result of convergence of a number of computing trends including the availability of low cost microprocessors, high speed networks, and software for high performance distributed computing. The node may be the low cost/performance PC, and Linux may be used as an operating system. When a single calculation which cannot be divided is performed in the clustered computing environment, the calculation is not different from a calculation performed in one node. However, when calculations which may be divided are distributed and processed by a plurality of nodes, the performance is improved in proportion to the number of nodes.

Therefore, the clustered computing environment in accordance with the embodiment of the present invention is based on a plurality of MICs, GPGPUs, and CPUs, but is not limited thereto.

The node search unit 110 is configured to search for the node required for running a job requested by a user within an available resource group of the clustered computing environment. That is, the node search unit 110 searches for the node including necessary resources requested by the user in the available resource group. At this time, the necessary resources refer to resources required for running the job requested by the user.

The node existence determination unit 120 is configured to determine whether or not there exists a node having available necessary resources required for running the job requested by the user.

The resource change unit 130 is configured to change at least one of the necessary resources to alternative resources, when the node existence determination unit 120 determines that there is no node having the necessary resources available, and searches for available resources through the node search unit 110. That is, when the node existence determination unit 120 determines that the necessary resources required for running the job requested by the user are insufficient, the resource change unit 130 changes the necessary resources to the alternative resources based on a preset priority, and then searches for available resources through the node search unit 110 and the node existence determination unit 120.

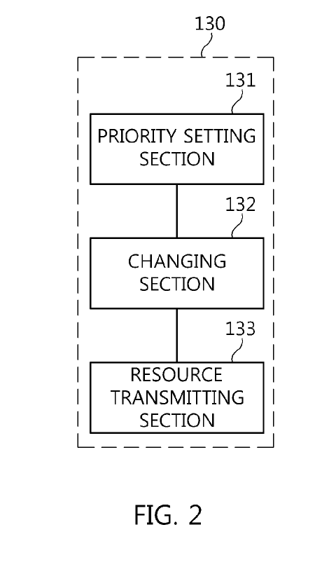

For this operation, referring to FIG. 2, the resource changing unit 130 may include a priority setting section 131, a changing section 132, and a resource transmitting section 133.

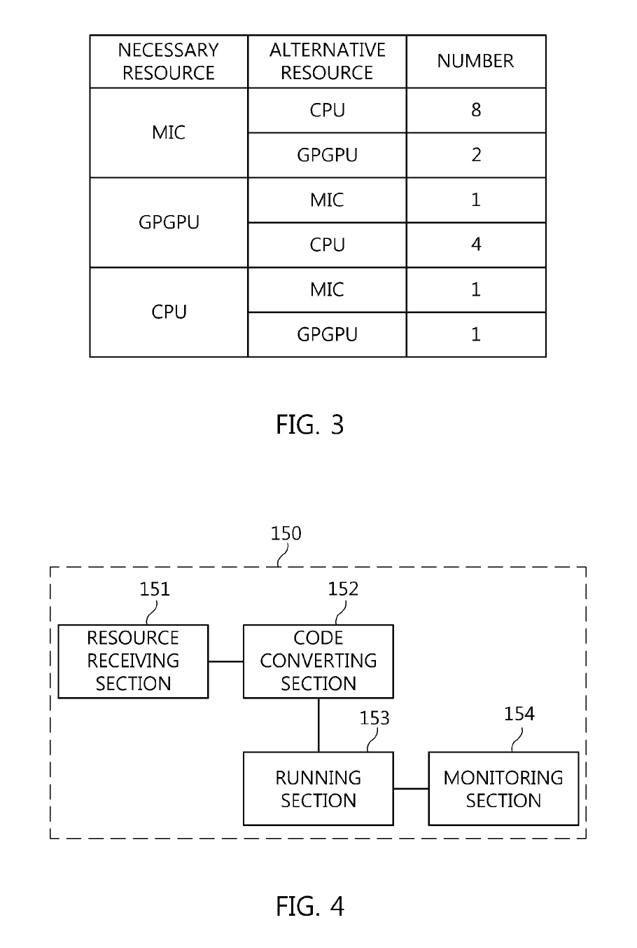

The priority setting section 131 is configured to set the priority in order of MIC, GPGPU, and CPU according to the numbers of components within the clustered computing environment. In order to change at least one of the necessary resources to the alternative resources, the priority setting section 131 provides information as shown in FIG. 3 such that resources which are not relatively common may be first changed to the alternative resources.

The changing section 132 is configured to change the necessary resources to the alternative resources based on the preset priority. Referring to FIG. 3, a resource positioned in the upper side of a necessary resource column may be first changed to an alternative resource. Furthermore, when the same necessary resource is replaced, a resource positioned in the upper side of an alternative resource column has a higher priority. For example, the changing section 132 searches for an MIC having a high priority as an alternative resource to replace a CPU, and then searches for a GPGPU when there is no MIC available. Furthermore, when a user wants one GPGPU but there is no GPGPU available, the changing section 132 first checks whether or not one MIC is available instead of one GPGPU. Then, when there is no MIC available, the changing section 132 searches for a node having four available CPUs, and changes the necessary resource to the alternative resources

The resource transmitting section 133 is configured to transmit the changed alternative resources to the node search unit 110.

The resource allocation unit 140 is configured to allocate the resources of the corresponding node to run a job, when the node existence determination unit 120 determines that the node has the necessary resources available.

The job execution unit 150 is configured to receive the resources of the corresponding node from the resource allocation unit 140 and execute the job requested by the user.

For this operation, the job execution unit 150 may include a resource receiving section 151, a code converting section 152, a running section 153, and a monitoring section 154.

The resource receiving section 151 is configured to receive the resources of the node determined by the node existence determination unit 120 or the alternative resources.

The code converting section 152 is configured to perform job code conversion such that the job may be executed in the alternative resources when the alternative resources are received. That is, the code converting section 152 performs the job code conversion such that the job utilizes the alternative resources to exhibit the same effect as in the necessary resources.

When the user separately writes a code for each resource by considering heterogeneous resources while writing a job execution code and then submits the written code, the code conversion section 152 selects a code corresponding to the allocated resource as a code for job execution. When the user does not separately write a code, the code conversion section 152 may convert a code through an automatic conversion device (not illustrated) such that the job can be executed using the alternative resources.

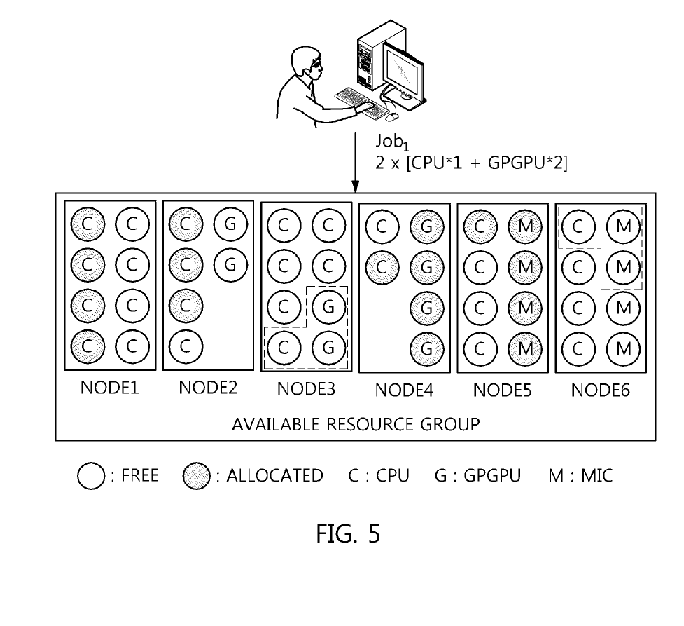

The running section 153 is configured to run the job requested by the user, using the allocated resources. FIG. 5 illustrates an example of resource allocation using alternative resources in accordance with the embodiment of the present invention. In FIG. 5, the user makes a request to use two sets of resources, each of which includes one CPU and two GPGPUs (2×[CPU*1+GPGPU*2]), in order to run a job Job1. However, since resources are allocated to run other jobs, only one node Node3 satisfies the corresponding condition. Therefore, available alternative resources may be utilized. At this time, when the alternative resource information is configured as shown in FIG. 3, GPGPU may be replaced by a MIC or four CPUs. So the candidates of alternative resources allocation is (CPU*1+GPGPU*1+MCU*1) or (CPU*1+MIC*2). In this case, a node Node6 satisfies the condition. Therefore, the user runs the job Job 1 using the nodes Node3 and Node6. At this time, a code written by the user may be normally executed in the node Node3 having one CPU and two GPGPUs available. However, in order that the job Job1 is executed by the node Node6 having one CPU and two MICs available, the code written to be executed on the GPGPU is converted into a code to be executed by the MIC.

The monitoring section 154 is configured to check whether the necessary resources become available or not, when the job requested by the user is executed using the alternative resources. That is, when the job is executed using the alternative resources, the monitoring section 154 monitors whether the necessary resources required for running the job requested by the user become available or not. When the monitoring section 154 determines that the necessary resources become available, the corresponding resources may be allocated to run the job again, or the job executed in the alternative resources may be moved to the necessary resources required for running the job.

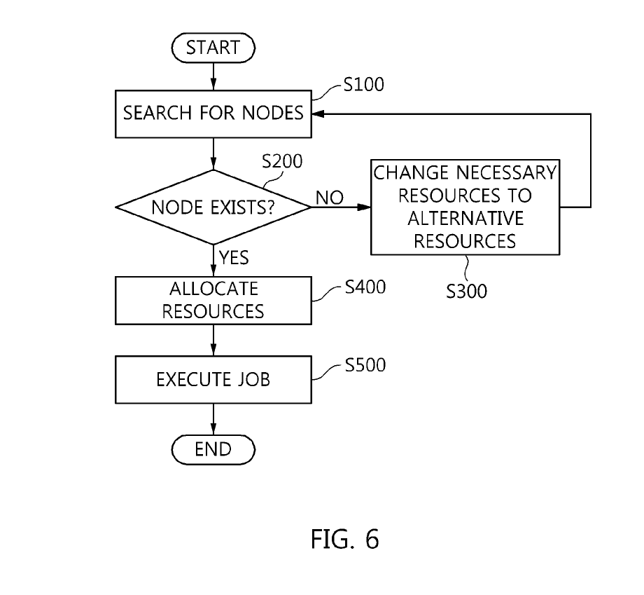

FIG. 6 is a flow chart showing the method for resource allocation in a clustered environment in accordance with the embodiment of the present invention.

Referring to FIG. 6, the node search unit 110 first searches for the node corresponding to necessary resources required for running a job requested by a user, within an available resource group of the clustered computing environment, at step S100.

Then, the node existence determination unit 120 determines whether or not there exists a node having the necessary resources available at step S200.

Then, when it is determined that there is no node having the necessary resources available, the resource changing unit 130 changes the necessary resources to alternative resources based on the preset priority at step S300. The resource changing unit 130 sets the priority of the necessary resources and the alternative resources for MIC, GPGPU, and CPU according to the numbers of components used in the clustered computing environment. Then, based on the priority set in order of MIC, GPGPU, and CPU, the changing unit 130 changes the necessary resources to the alternative resources, and the changed alternative resources are allocated through the node search step and the node existence determination step, in order to run the job.

Then, when it is determined that there exists a node having the necessary resources available, the resource allocation unit 140 allocates the resources of the corresponding node to run the job at step S400.

Finally, the job execution unit 150 receives the resources of the corresponding node or the alternative resources and runs the job requested by the user at step S500. When the alternative resources are allocated, the code converting section may perform code conversion, and when the alternative resources are used to run the job, the monitoring section may monitor whether the necessary resources become available or not.

As such, the apparatus and method for resource allocation in a clustered computing environment in accordance with the embodiment of the present invention does not wait until a node having available resources required for running a job requested by a user emerges, but allocates alternative resources to run the job. Therefore, the apparatus and method may shorten a user's response time, thereby improving the overall performance of the system. Furthermore, the apparatus and method constructs and utilizes uniform standards for changing the necessary resources required for executing the job requested by the user to the alternative resources. Therefore, the utilization of the entire resources may be improved to increase the efficiency of the system operation.

While the present invention has been described with respect to the specific embodiments, it will be apparent to those skilled in the art that various changes and modifications may be made without departing from the spirit and scope of the invention as defined in the following claims.

What is claimed is:

1. An apparatus for resource allocation in a clustered computing environment, comprising:
a node search unit configured to search for a node corresponding to necessary resources required for running a job requested by a user, within an available resource group of the clustered computing environment;
a node existence determination unit configured to determine whether or not there exists the node having the necessary resources available; and
a resource changing unit configured to change at least one of the necessary resources to alternative resources based on a preset priority and then allocate the alternative resources, when it is determined that there is no node having the necessary resources available.

2. The apparatus of claim 1, wherein the clustered computing environment is constructed based on a plurality of many integrated cores (MIC), general purpose graphic processing units (GPGPU), and central processing units (CPU).

3. The apparatus of claim 2, wherein the resource changing unit changes the necessary resources which are rare to the alternative resources preferentially among the necessary resources in the clustered computing environment.

4. The apparatus of claim 3, wherein the resource changing unit comprises:
a priority setting section configured to set the priority of the necessary resources and the alternative resources in order of MIC, GPGPU, and CPU;
a changing section configured to change the necessary resources to the alternative resources based on the preset priority; and
a resource transmitting section configured to transmit the changed alternative resources to the node search unit.

5. The apparatus of claim 1, further comprising a resource allocation unit configured to allocate necessary resources of the node, when the node existence determination unit determines that the corresponding node has the necessary resources available.

6. The apparatus of claim 1, further comprising a job execution unit configured to receive the necessary resources of the corresponding node or the alternative resources and run the job requested by the user.

7. The apparatus of claim 6, wherein the job execution unit comprises:
a resource receiving section configured to receive the necessary resources of the corresponding node determined by the node existence determination unit or the alternative resources;
a code converting section configured to convert codes for the job so that the job can be executed on the alternative resources, when the alternative resources are received;
a running section configured to run the requested job using the received necessary resources of the corresponding node or the converted alternative resources; and
a monitoring section configured to monitor whether the necessary resources become available or not, when the alternative resources are used to run the requested job.

8. A method for resource allocation in a clustered computing environment, comprising:
searching for a node corresponding to necessary resources required for running a job requested by a user, within an available resource group of the clustered computing environment;
determining whether or not there exists the node having the necessary resources available; and
changing at least one of the necessary resources to alternative resources based on a preset priority and allocating the alternative resources, when it is determined that there is no node having the necessary resources available.

9. The method of claim 8, wherein the changing the necessary resources to the alternative resources changes the necessary resources which are rare to the alternative resources preferentially among the necessary resources in the clustered computing environment.

10. The method of claim 9, wherein the changing the necessary resources to the alternative resources changes the necessary resources to the alternative resources based on the priority set in order of MIC, GPGPU, and CPU, and allocates the changed alternative resources.

11. The method of claim 8, further comprising allocating necessary resources of the node, when the corresponding node has the necessary resources available.

12. The method of claim 11, further comprising receiving the necessary resources of the corresponding node or the alternative resources and running the job requested by the user.

13. The method of claim 12, wherein the receiving the necessary resources of the corresponding node or the alternative resources and running the job requested by the user, converts codes for the job so that the job can be executed on the alternative resources when the alternative resources are allocated, and monitors whether the necessary resources become available or not when the alternative resources are used to run the requested job.

14. The method of claim 13, wherein the receiving the resources of the corresponding node or the alternative resources and running the job requested by the user, receives the necessary resources to run the job again, or moves the job executed in the alternative resources to the necessary resources required for running the job, when it is determined that the necessary resources become available.
